(19) United States
(12) Patent Application Publication
(10) Pub. No.: US 2006/0102274 A1
(43) Pub. Date: May 18, 2006

(54) Method and device for clockwise and counterwise winding of a sheet of material

(75) Inventor: Edgar Gandelheidt, Worms (DE)

Correspondence Address: COHEN, PONTANI, LIEBERMAN & PAVANE, 551 FIFTH AVENUE, SUITE 1210, NEW YORK, NY, 10176, US

(73) Assignee: Kiefel Extrusion GmbH

(21) Appl. No.: 11/274,969

(22) Filed: Nov. 16, 2005

(30) Foreign Application Priority Data
Nov. 18, 2004 (DE) 10 2004 055 734.9

(51) Int. Cl. B65H 81/00; B31C 1/00

(52) U.S. Cl. 156/184; 156/250; 156/443

(57) ABSTRACT

A contact roll winding device comprises a contact roll, a cutting device, a winding station with a winding shaft receiving device, and two guide rollers, one of which guides a sheet of material to the contact roll during a counterclockwise winding operation, while the other, which is arranged symmetrically with respect to the cutting device, guides the sheet of material to the contact roll during a clockwise winding operation. After the sheet of material has been cut by the cutting device, it is held against the contact roll by negative pressure until the leading end of the sheet of material reaches the winding station where there is a new winding shaft.

### BACKGROUND OF THE INVENTION

1. Field of the Invention

The invention relates to a method for the clockwise and counterclockwise winding of a sheet of material on a winding shaft, in which the sheet of material is guided selectively counterclockwise or clockwise about a contact roll with a wrap angle that allows transport of the sheet of material. The invention also relates to a contact roll winding device.

2. Description of the Related Art

DE 42 13 712 C2 describes a method and device of the above type, which use a cutting device with guide rollers for the sheet of material. The cutting device rotates about the axis of rotation of the contact roll and is rotated between the contact roll and the sheet of material during clockwise winding. During counterclockwise winding, the cutting device is rotated from a lower initial position into an upper cutting position to form a loop. In both directions of rotation, the sheet of material is cut in a place at which the sheet of material is not in contact with the contact roll. This can lead to a turning up of the freed end of the sheet of material and thus to an out-of-round wound roll. During the counterclockwise operating mode, to form a loop in the sheet of material, the contact between the contact roll and the wound roll must be discontinued. Another disadvantage of this method and device is that the bearing and rotation of the cutting device involves considerable expense.

U.S. Pat. No. 5,848,761 describes a cutting and transporting roll for sheets of material, in which the contact roll is divided into several chambers. A linear blade, which is guided over the complete width of the contact roll, is located between two chambers. The roll bearing has pressure medium channels that allow the compressed air required to move the blade to be supplied. A disadvantage of this method and the corresponding device is that the cut is carried out from one side, which can result in a displacement of the sheet of material. Another disadvantage is that the cutting blade is oriented parallel to the axis so that a cut perpendicular to the longitudinal direction of the sheet of material is produced. This results in the formation of a sort of impact edge, which results in out-of-roundness of the wound roll. Furthermore, the contact roll has a very slightly smaller diameter at the location of the groove from which the cutting blade emerges, which results in out-of-roundness of the contact roll. Since the cut takes a certain amount of time, a part of the sheet of material is already in the cut-off state without a previously cut part already being below the wound roll. This can cause the sheet to turn up, which can be prevented only by expensive means, for example, a large vacuum chamber with a powerful vacuum.

Furthermore, U.S. Pat. No. 6,766,722 describes a cutting and transport roller, which has rotating blades inside the contact roll. A disadvantage here is that most of the cut is carried out leading away from the contact roll. Another disadvantage is that the cut is carried out perpendicularly to the sheet of material.

The last two cutting and transport rolls have the common disadvantage that the required power, for example, electric power or compressed air, must be supplied through journals. The entire mechanism of the cutting device is located inside the contact roll, which makes the maintenance and repair of the cutting device considerably more difficult. In addition, this makes the balancing of the contact roll more complicated.

### SUMMARY OF THE INVENTION

An object of the invention is to allow winding without turn-up during both clockwise and counterclockwise winding with low technical expense.

This object is achieved by executing a cut from the outside towards the contact roll, with the sheet of material lying or wrapping closely against the contact roll, for the purpose of cutting the sheet of material during a roll change, and by producing adherence between the sheet of material and the contact roll at least from the beginning of the cutting operation until a leading end of the sheet produced in this way reaches a winding station.

These measures allow the arrangement of a cutting device that is stationary in the circumferential direction of the contact roll and is located outside the contact roll so that during the execution of the cut, the freed leading end of the sheet cannot turn up due to the adherence that is produced but rather remains on the contact roll until the winding station is reached. Examples of suitable cutting devices are a roll blade, a cutting blade designed as a scraper, or a cleaver that can be rotated against the contact roll. As a result of the cutting from the outside towards the contact roll, lifting of the sheet of material is prevented. In addition, this measure results in a simple contact roll, which is free of cutting devices on the inside and also requires no groove for the passage of the cutting device so that the disadvantages described above, especially the measures for preventing lifting of the sheet of material and the problems caused by the arrangement of the cutting device inside the contact roll and the out-of-roundness of the wound roll, are avoided.

It is advantageous for the adherence to be produced by the application of a negative pressure that acts between the contact roll and the sheet of material. However, it is also possible to produce the adherence by an electrostatic effect between the contact roll and the sheet of material.

A contact roll winding device for the clockwise and counterclockwise winding of sheets of material includes a cutting device which is arranged in such a way that it cuts towards the contact roll, which is stationary in the circumferential direction of the contact roll, and which is arranged with separation in the circumferential direction from a winding station, wherein the separation allows a sufficient arc of wrap of the sheet of material on the contact roll, independently of the direction of feed, according to the given direction of rotation. The contact roll has a surface that is insensitive to the action of the cutting device and allows adherence of the sheet of material. A device for producing adherence of the sheet of material can be applied at least from the beginning of the execution of the cut until the leading end of the sheet reaches the winding station.

This device has several important advantages compared to the prior art. One of these advantages is that a simple cutting device that is stationary in the circumferential direction of the contact roll is used so that a special drive for shifting or rotating the cutting device and the necessity of balancing the contact roll are eliminated. In addition, the problems that arise when the cutting device is installed inside a contact roll with respect to maintenance and repair and with respect to supplying the drive power for the cutting device are avoided. Cutting from the outside towards the contact roll also avoids the disadvantages that are associated with lifting of the sheet of material and that are to be seen especially in the danger of turn-up of the freed leading end of the sheet.

In an advantageous embodiment of the invention, the surface of the contact roll is designed to resist cutting, which can be achieved, for example, by hard chromium plating or special hardening methods.

In another embodiment of the invention, if the surface of the contact roll is at least partially permeable to air, for example by providing fine holds, and the contact roll can be connected to a vacuum source, it is possible to suck the sheet of material against the contact roll at least from the beginning of the execution of the cut until the leading end of the sheet produced by the cut has reached the winding station. Since the cut is guided from the outside towards the contact roll, lifting of the sheet of material is avoided, which means that a relatively weak vacuum is sufficient to reliably guide the sheet of material to the winding station so that material stresses and displacements of the sheet of material, especially turning up of the sheet of material, are prevented.

However, it is also possible to provide a device for producing electrostatic adherence between the contact roll and the sheet of material in order to achieve the same advantages with respect to the effects on the sheet of material as are achieved by the application of a vacuum. This may be done by a charge generator connected to one of the sheet and the contact roll.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIGS. 1 to 3 show a schematic representation of the essential parts of a winding device for the counterclockwise winding of a sheet of material.

FIGS. 4 to 6 show a schematic representation, corresponding to FIGS. 1 to 3, of a winding device for the clockwise winding of a sheet of material.

### DETAILED DESCRIPTION OF THE PRESENTLY PREFERRED EMBODIMENTS

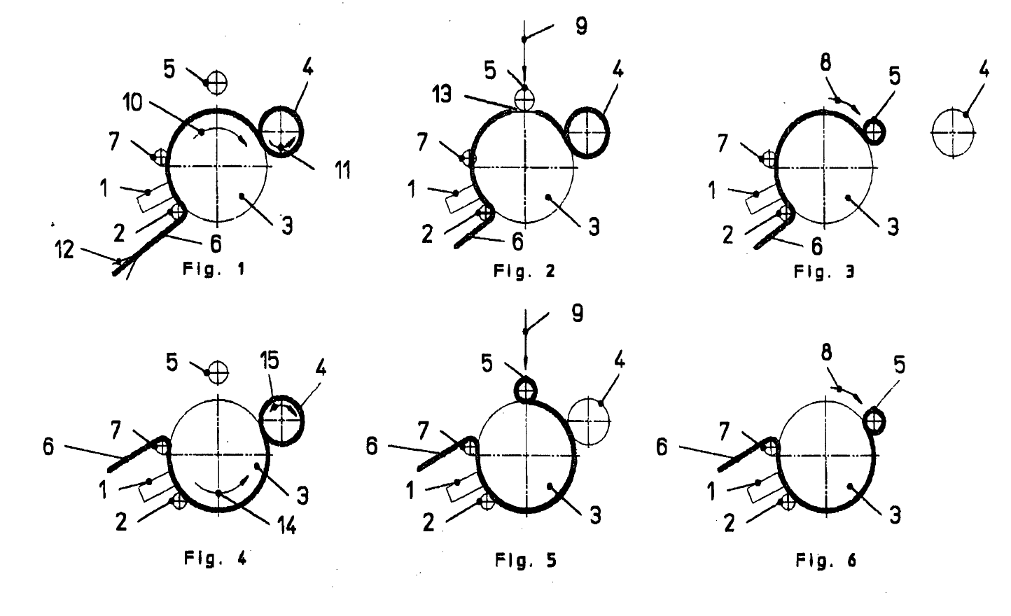

The same winding device is shown in all of FIGS. 1 to 6. Therefore, the same reference numbers are used throughout the drawings.

As the drawings show, the contact roll winding device comprises a contact roll 3, which, as shown in FIGS. 1 to 3, can be driven clockwise as indicated by the arrow 10 in FIG. 1 to produce counterclockwise winding and thus a wound roll 4. The wound roll 4, as shown in FIGS. 1 and 2, is located in a winding station. The winding station is not shown in detail. To produce the wound roll 4, the contact roll 3 is in constant contact with the wound roll 4 so that the direction of rotation of wound roll 4, as indicated by arrow 10, is changed to the opposite direction, as indicated by arrow 11 in FIG. 1. To produce a counterclockwise winding operation, as illustrated in FIGS. 1 to 3, a sheet of material 6 is fed to the contact roll 3 in the direction of the arrow 12 in FIG. 4 over a guide roller 2, which is arranged so close to the contact roll 3 that the sheet of material 6 after partially wrapping around the guide roller 2 lies closely against the contact roll 3.

To carry out a roll change, in which the finished wound roll 4 is removed from the winding station, as shown in FIG. 3, it is necessary to cut the sheet of material 6. This is accomplished with a cutting device 1, which is arranged stationary in the circumferential direction of the contact roll 3 and, viewed circumferentially, is sufficiently distant from a winding shaft receiving device and a first winding station 9 that a sufficiently large wrap angle remains for the contact roll 3 to carry along the sheet of material 6. A new winding shaft 5 is brought up to the contact roll 3 by the first winding station 9, which also comprises the winding shaft receiving device, as illustrated in FIG. 2. The leading end 13 of the sheet that is formed after the cutting of the sheet of material 6 by the cutting device 1 is held on the contact roll 3 by an adhesive force produced on the surface of the contact roll 3 until it reaches the new winding shaft 5, as FIG. 2 shows. After winding has started, the new winding shaft is transferred to a second winding station in the direction of arrow 8 shown in FIG. 3. The finished wound roll 4 is removed from the second winding station, as indicated in FIG. 3.

FIGS. 4 to 6 show essentially the same process, with the exception that the contact roll 3, as indicated by arrow 14 in FIG. 4, is rotated counterclockwise so that the resulting wound roll 4 rotates clockwise. FIG. 4 thus shows the clockwise winding process and the formation of a wound roll 4 in the second winding station. FIG. 5 shows the state after the cutting of the sheet of material 6 by the cutting device 1, which is stationary in the circumferential direction of the contact roll 3, and the already started winding operation onto a new winding shaft 5 in the first winding station 9, which also comprises the winding shaft receiving device. In this regard, it is apparent that the finished wound roll 4 is about to be removed, as FIG. 5 indicates. FIG. 6 shows the transfer of the winding shaft 5, on which winding has just begun, into the second winding station in the direction of arrow 8 in FIG. 6.

As FIGS. 4 to 6 show, to reverse the direction of rotation, the sheet of material is no longer guided over the guide roller 2 but rather over a guide roller 7, which is arranged symmetrically to the guide roller 2 with respect to the cutting device 1 and likewise guides the sheet of material 6 to rest against the contact roll 3.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for clockwise and counterclockwise winding of a sheet of material on a winding shaft, the method comprising:
guiding the sheet of material selectively counterclockwise or clockwise on a contact roll with a wrap angle which allows transport of the sheet of material by the contact roll;
cutting the sheet of material from an outside of the contact roll towards the contact roll during a roll change, with the sheet of material lying closely against the contact roll; and
producing adherence between the contact roll and the sheet of material at least from a beginning of the cutting until a leading end of the sheet of material produced by the cutting reaches a winding station.

2. The method of claim 1, wherein the adherence is produced by a negative pressure between the contact roll and the sheet of material.

3. The method of claim 1, wherein the adherence is produced by an electrostatic effect between the contact roll and the sheet of material.

4. A contact roll winding device for clockwise and counterclockwise winding of a sheet of material, comprising:
a contact roll having a surface for guiding the sheet of material;
a winding station;
a cutting device stationary in a circumferential direction of the contact roll for cutting the sheet of material towards the contact roll, the cutting device being separated in a circumferential direction from the winding station so that an arc of wrap of the sheet of material is on the contact roll regardless of whether the contact roll is rotated counterclockwise or clockwise;
a device for producing adherence between the contact roll and the sheet of material at least from a beginning of the cutting until a leading end of the sheet of material produced by the cutting reaches the winding station,
wherein the surface of the contact roll is insensitive to the cutting.

5. The device of claim 4, wherein the surface of the contact roll is resistant to the cutting.

6. The device of claim 4, wherein the surface of the contact roll is at least partially permeable to air, and the contact roll can be connected to a vacuum source.

7. The device of claim 4, wherein the adherence producing device is operable to produce electrostatic adherence between the contact roll and the sheet of material.
